(19) United States
(12) Patent Application Publication
(10) Pub. No.: US 2003/0202543 A1
(43) Pub. Date: Oct. 30, 2003

(54) Aggregate processing of information during network transmission

(76) Inventors: Richard K. Karlquist, Cupertino, CA (US); Ken A. Nishimura, Fremont, CA (US); Jerry J. Liu, Sunnyvale, CA (US); Matthew Johnson, Half Moon Bay, CA (US); Michael C. Higgins, Palo Alto, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/131,857

(22) Filed: Apr. 25, 2002

(51) Int. Cl. H04J 3/12; H04L 12/54; H04L 12/28

(52) U.S. Cl. 370/522; 370/429; 370/400

(57) ABSTRACT

Aggregate processing of information during network transmission. Information requests are redirected to cause the information to be returned to a processing node where processing takes place before the processed information is returned to the requester. Redirection for processing may be initiated by the requester, or may be initiated on behalf of the requester. Processing nodes may be distributed. Processing requests may be nested so that after a first processing action takes place on data flowing through the network, a second processing action takes place.

### BACKGROUND OF THE INVENTION

1. Field of the Invention

The present invention pertains to the processing of information passed through digital networks, and to performing ancillary processing on information as it is passed through those networks.

2. Art Background

Digital information passes through networks such as the Internet from a source to a destination. The majority of this information is passed in packet form using TCP/IP protocols. Data in one form, a picture, a sound, a document, or a program for example, is split into packets at the source and sent to the destination. Packets flow through the network, passing through nodes which store incoming packets and then forward them on their way to the destination where the packets are recombined. Successive packets may not follow the same route through a network, and may arrive out of order. Information is typically requested using higher-level protocols, such as HTTP, SMTP, or FTP requests.

Additional processing is often performed at the destination after the entire assembly of packets has been received. Examples of this processing include virus scanning, scanning image or sound files for watermarks, format conversion, or keyword scanning.

### SUMMARY OF THE INVENTION

Information flowing through a network is aggregated and processed during transmission. Information requests are redirected to cause the information to be returned to a processing node where processing takes place before the processed information is returned to the requester. Information requests are redirected in a manner sufficient to insure that enough information is aggregated at a processing node to undertake the processing required. Redirection for processing may be initiated by the requester, or on behalf of the requester. Processing nodes may be distributed and specialized.

### BRIEF DESCRIPTION OF THE DRAWINGS

The present invention is described with respect to particular exemplary embodiments thereof and reference is made to the drawings in which:

FIG. 1 shows a computer network,

FIG. 2 shows a computer network with processing nodes.

### DETAILED DESCRIPTION

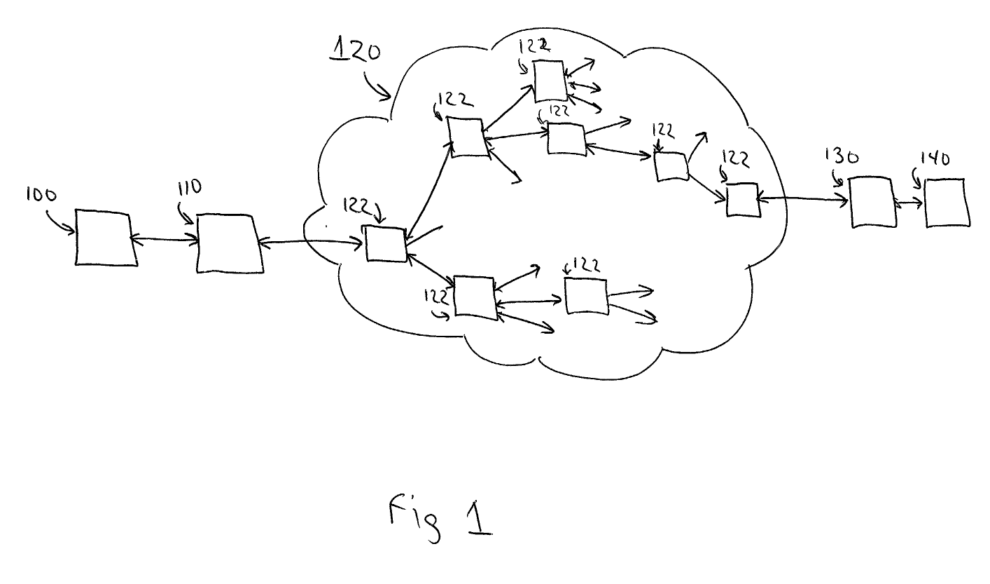

FIG. 1 shows a computer network. A requester 100 makes a request for information addressed to source 140. The request passes in packet form through access node 110 to network 120 using TCP/IP protocols. The connection between requester 100 and access node 110 may be wired or wireless. This request is typically framed in a higher level protocol such as HTTP, SMTP, or FTP, as is known to the art. Packets flow through network 120 using nodes 122. Packet switching protocols such as TCP/IP do not require that successive packets take the same path, or even that they arrive in sequence at their destination. Routing information kept by network 120 determines the paths the packets take. Packets arrive at router 130 for source 140. Source 140 responds to the request by sending a stream of packets addressed to requester 100.

Nodes 122, access node 110, and router 130 operate in a store-and-forward fashion, receiving packets, storing them briefly, then retransmitting them.

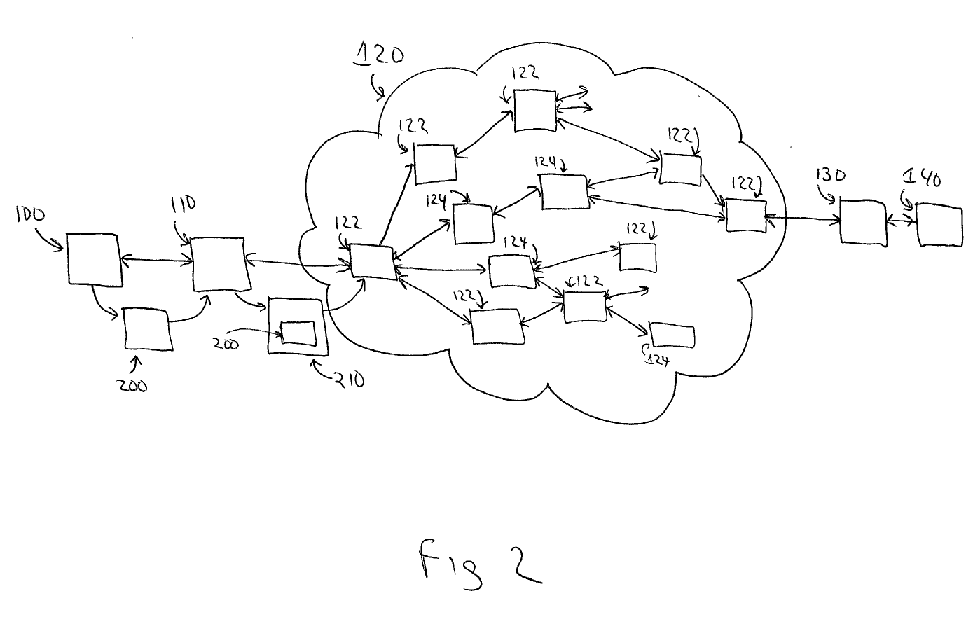

According to the present invention, as shown in FIG. 2, processing nodes 124 are adapted to aggregate and process information during transmission. Processing during transmission according to the present invention reduces the bandwidth required for the connection between requester 100 and access node 110, or reduces the processing which must be performed by requester 100.

Requester 100 sends a request 200 to source node 140 for information. Request 200 is routed through processing node 124. This is done by placing request 200 in an envelope 210, directing the request to node 124, specifying node 140 as the source. This envelope function may be applied by requester 100, or by an intermediate node such as access node 110. The envelope function may also be applied by source node 140. In this example, router 110 places request 200 in envelope 210, and sends request 210 to node 124. Node 124 sends the request for information on to source node 140. Source 140 receives a request from node 124 rather than requester node 100. Source node 140 responds to the request by sending packets back to node 124.

Node 124 aggregates the information from node 140 and processes it prior to sending the information in packet form back to requesting node 100. The amount of aggregation performed depends on the type of information and the type of processing. Nodes may specialize in handling different types of information, or in different types of processing.

A virus-scanning node, for example, may require that a complete file attachment be aggregated prior to being scanned. This is particularly true if compressed archives are to be scanned; the entire archive may be needed so that decompression can occur for the needed scanning. This necessitates that the processing node contain enough local storage to store the entire file for the required processing. Such scanning in a processing node 124 eliminates the need to perform such scanning at requester 100, and also eliminates the requirement that requester 100 maintain the overhead of virus definition files and the like. When a potential virus is discovered, requester 100 is sent a notification of the virus, which reduces the transmission bandwidth required.

A node scanning for unsolicited e-mail (spam), processing requests using email standards such as POP or SMTP, may only need to look at message header information and the message beginning, searching for known spam indications, open relays in the message header, or other indicia known to the spam filtering art. As with the case of virus scanning, performing spam scanning in a node eliminates the need to perform such scanning by requester 100, and eliminates the requirement that requester 100 maintain the overhead of definition files and the like.

A watermark or signature scanning node, for example for scanning images using standards such as JPG or GIF, or sound files using standards such as MP3 or WAV, on the other hand need only aggregate enough information to search for signatures and/or watermarks. For example, if a target watermark in a sound file is repeated at a known rate, only enough information to insure detection need be aggregated. Complex coding methods such as JPEG4 may require more aggregation to effectively search for signatures or watermarks. A second type of watermark processing node is a node which adds watermarks to digital media such as still images, moving images, or sound files. Watermark processing is computationally intensive; performing this computation in a processing node 124 reduces the computational requirements placed on requester 100.

An example of a format conversion node is color space reduction, where an image file in a format such as JPEG is made by a requester having a color display which is limited in size or in color depth. As an example of format conversion, consider the conversion of a 1280 by 1024 pixel, 24-bit color image to be displayed on a 320 by 240 pixel 8-bit color display. For requester 100 to perform this conversion requires the entire 1280 by 1024 pixel image be sent, and then substantial computation must be performed to rescale the image and reduce the number of colors. Performing this conversion in a processing node 124 results in a much smaller image being returned to requester 100, and eliminates the computation required by requester 100. Format conversion is also used in text-to-speech conversion, for example in having e-mail messages read aloud. While this conversion increases the amount of data sent to requester 100, it greatly reduces the computation required by requester 100, and allows, for example, more complex text-to-speech models than could be hosted on requester 100.

Processing nodes 124 require sufficient local storage to perform their particular task. Given that this storage is a finite resource, provision must be made for handling requests when sufficient storage is not available. In a first method of handling situations when node 124 does not have sufficient resources to handle the request, the node rejects the request. This puts the burden back on requesting node 100. A second method queues the request until sufficient resources are available, or are predicted to be available to process the request. In a third method of dealing with resource constraints, node 124 is considered to be a member of a class of nodes providing the same service. When node 124 is resource limited, it redirects the request on to another node of the same class.

The envelope process of the current invention may also be nested, so that multiple services are provided on requests. A first envelope can request virus scanning, for example, while a second envelope inside the first envelope requests signature or watermark scanning.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. In a digital network for transferring information, a requester connected to network nodes through an access node, the requester making a request for information to a source node connected to the network, the method of providing processing on the requested information through the use of processing nodes comprising:
redirecting the request from the requester to the source so that information is transferred from the source to a processing node which provides processing on the information as it is transferred, and sends the processed information from the processing node to the requester.

2. The method of claim 1 where the connection between the requester and the access node is a wired connection.

3. The method of claim 1 where the connection between the requester and the access node is a wireless connection.

4. The method of claim 1 where redirection is initiated by the requester.

5. The method of claim 1 where redirection is initiated on behalf of the requester.

6. The method of claim 1 where redirection is initiated on behalf of the requester by the access node.

7. The method of claim 1 where redirection is initiated on behalf of the requester by the source node.

8. The method of claim 1 where the processing provided by the processing node includes virus scanning.

9. The method of claim 1 where the processing provided by the processing node includes spam detection.

10. The method of claim 1 where the processing provided by the processing node includes scanning for watermarks.

11. The method of claim 1 where the processing provided by the processing node includes adding watermarks.

12. The method of claim 1 where the processing provided by the processing node includes format conversion.

13. The method of claim 12 where the format conversion comprises conversion of textual information to speech.

14. The method of claim 1 where the processing performed by the processing node reduces the amount of information sent to the requester.

15. The method of claim 1 where the processing performed by the processing node reduces the amount of computation required by the requester.
